(19) United States
(12) Patent Application Publication
(10) Pub. No.: US 2011/0163185 A1
(43) Pub. Date: Jul. 7, 2011

(54) Quick Needle Pullback Mechanism To Clean The Needle Valves In Air Brushes

(76) Inventor: Raymond Wong, Alhambra, CA (US)

(21) Appl. No.: 12/428,101

(22) Filed: Apr. 22, 2009

(51) Int. Cl. B05B 7/12; B05B 7/32

(52) U.S. Cl. 239/414; 239/337; 239/407

(57) ABSTRACT

An air brush is provided with the quick needle pullback mechanism thereby allowing the user to apply quick flushes. This is composed of first pushing down on the trigger to open the air valve and then retracting the needle fully and allowing the needle to be pushed forward by the spring, effectively using the pressured air and paint to clean the nozzle. The distance of the pullback is regulated by a pre-set adjustment knob. A needle chuck and a needle lock perform the function of affixing to the needle, which regulates the paint or media flow. Under normal use, the pre-set adjustment knob defines the maximum paint output by stopping the needle from traveling backward farther than the preset position. When the user wishes to clean the nozzle, the pre-set adjustment knob may be dialed sufficiently back to allow the needle to be fully retracted by the quick pullback mechanism, thereby causing the nozzle to open up fully, allowing the extra paint to rush through the nozzle, and thereby cleaning the nozzle head area.

### FIELD OF INVENTION

The present invention concerns a novel air brush from which the needle can be retracted fully and easily as a means to clean the nozzle area and offers the ability to limit paint volume with a pre-set adjustment knob.

### BACKGROUND OF THE INVENTION

Air brush, a hand-held device that delivers a mixture of compressed air and paint through a needle valve, is used widely in many industries. In a single action air brush the trigger only allows the user to adjust the amount of pressured air as the amount of paint flow is traditionally adjusted separately, while in a double action air brush the trigger allows the user to adjust both the amount of pressured air and paint flow.

One of the problems for air brush users, especially serious artists, has been the clogging of the needle valve. As coagulated media (e.g., paint) accumulate in the needle valve area, the performance of the air brush becomes inconsistent. Without a means to keep the consistency of performance, for instance, artists would not be able to foresee the precise result of each paint stroke.

### DESCRIPTION OF RELATED ART

Traditionally, when the needle valve of an air brush is clogged, the common quick cleaning technique is to remove the rear handle cap first and then repeatedly pull back on the needle and allow the spring to push the needle forward again in quick bursts. This releases fresh media in quick impulses so that the clogged media can be eventually forced out. Although this technique is effective, it required the rear handle cap of the air brush to be first removed each time so the user can have access to the needle. This meant longer time to perform. As a result, many users would leave the rear handle cap off at all times. This meant direct access to the needle, but it exposes the needle and moving mechanisms of the airbrush to debris, paint, etc. and to possible damage if the air brush is dropped.

In order to provide this direct access to the needle, yet still be able to protect the airbrush, some current designs employ a cut-away handle. With two sides of the rear handle cap cut out, the user can access the needle while the rear handle cap is not removed. Although not removing the rear handle cap is an improvement, the introduction of the two holes on the side of the handle cap still exposes the needle and internal mechanisms to the debris, paint, etc.

It is therefore desirable for an easy means of quick pull back, that also protects the needle and moving mechanisms with a fully enclosed rear handle cap. To improve the feature set, this design will also integrate a traditional style pre-set knob adjustment.

### SUMMARY OF THE INVENTION

The present invention, i.e., the quick needle pullback mechanism, allows user an easy means to retract the needle completely to open up the nozzle and then close the valve completely. Repeated open-and-close action of the valve, while the trigger button (16) is pushed down to allow air passing through the nozzle, allows pressured air and fresh media to blow out coagulated media in the area. Since it takes little time and effort for user to apply this mechanism to clean the needle valve, users may perform the task frequently thereby avoiding the accumulation of coagulated media in the nozzle area and keeping the flow consistent and predictable.

This Quick Needle Pullback Mechanism may be used in airbrushes of any feed type (e.g., gravity fed, siphon fed) or trigger mechanism (e.g., single action, or dual action), as long as the media flow is controlled by a needle valve.

With an easy means of accomplishing that task, users of the air brushes can perform the task frequently, thereby achieving consistency, without the gradual slowing down of the media flow and sudden increase of the flow rate due to the coagulated paint being blown out of the nozzle by pressured air and fresh paint.

In addition to the Quick Needle Pullback mechanism, this deign also integrates the capability to limit the needle pull back distance with a pre-set adjustment knob. Normally, the pre-set knob is dialed sufficiently back to allow full needle motion. In this case, the user can in real-time adjust the media flow from zero to full volume in a single stroke. It also allows the user to perform quick flushes. However, in the event the user needs to maintain a consistent spray volume, the pre-set knob can be dialed in to limit the needle movement and thus the paint volume to the desired amount. The further the pre-set knob is dialed in, the less the needle can be moved back and therefore the smaller the media volume amount that is allowed to be sprayed.

### BRIEF DESCRIPTION OF THE DRAWINGS

FIG. 1 shows the entire air brush according to a preferred embodiment.

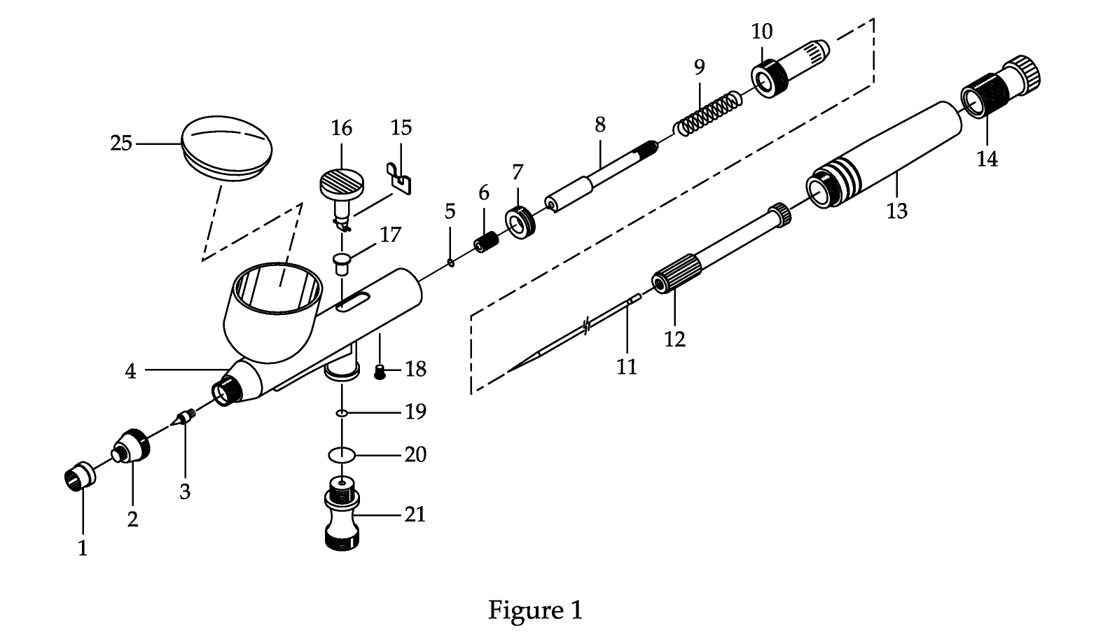

FIG. 2 is a sectional side view illustrating the individual components of the quick needle pullback mechanism with the pre-set adjustment knob.

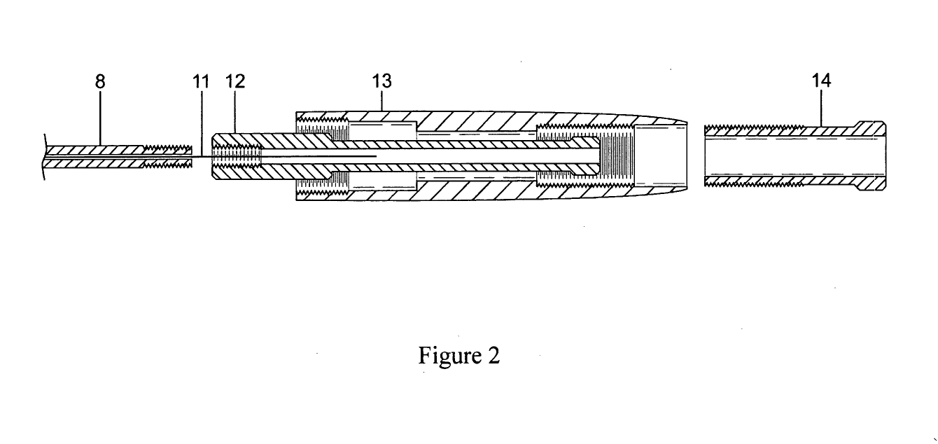

### DETAILED DESCRIPTION OF THE PREFERRED EMBODIMENT

The needle (11) is secured to the needle chuck (8) by tightening the needle lock (12), which we also refer to as the quick pull handle. By default, spring (9) keeps the needle chuck (8) pushed forward (towards the nozzle (3)), and holds the needle valve in fully closed position. Pushing down on the trigger (16) opens the air valve (21), allowing air to flow from the bottom inlet of the air valve (21), through the air valve (21), through the body (4), and to the nozzle cap (2). Pulling back on the trigger (16) causes the actuator (15) to be pulled back, moving the needle chuck (8) back, thereby moving the needle (11) back. This opens up the nozzle (3) to allow paint stored in the reservoir of the body (4) to spray out by the pressured air. The further back the trigger (16) is pulled, the more paint volume is allowed to be sprayed out of the nozzle (3).

The rear handle cap (13) is used to protect the moving airbrush mechanisms, i.e., the needle (11), the quick pull handle (12), and the needle chuck (8). The pre-set adjustment knob (14) is attached at the rear end of the rear handle cap (13). When the air brush is used normally, the pre-set adjustment knob (14) may be dialed in, limiting the needle's ability to move back by blocking the movement of the quick pull handle (12), and therefore control the maximum amount of paint output. When the pre-set adjustment knob (14) is dialed all the way forward, the needle is prevented from moving back at all, effectively disabling the trigger backward movement (16).

Dialing the pre-set adjustment knob (14) sufficiently back allows the needle (11) to be fully retracted by pulling the quick pull handle (12), which extends beyond the rear handle cap (13) and the pre-set adjustment knob (14).

When the paint starts to coagulate at the nozzle (3), with the pre-set adjustment knob (14) sufficiently back, the user can first push down on the trigger (16) and then apply a quick flush by pulling back on the quick pull handle (12), which effectively retracts the needle (11), and then allow the needle (11) to be fully pulled forward by the spring (9). Repeating the quick flush several times is an effective way to clear the clogging of the nozzle (3).

The rear handle cap (13) is threaded at the back end for attachment of the pre-set adjustment knob (14) and unthreaded farther inside, i.e., forward, to serve as tubular groove for the quick pull handle (12) to travel in the axial direction.

The pre-set adjustment knob (14), which is attached to the back end of the rear handle cap (13) by thread, is a sleeve which allows the quick pull handle (12) to be extended out of the backend of the pre-set adjustment knob (14) and move back and forth.

It is to be understood that the present invention is not limited to the embodiment described above, but encompasses any and all embodiment within the scope of the following claims.

What is claimed is:

1. An improved air brush in which the amount of media is controlled by a needle valve, wherein the improvement comprises:
1) A quick pull handle that extends beyond a rear handle cap so users may use the said quick pull handle as handle to pull the said needle;
2) An affixing means for affixing to the end of the needle to the quick pull handle;
3) A limiting means for limiting the maximum distance that the needle can be pulled back.

2. An affixing means according to claim 1, comprising a needle chuck and a needle lock couple to accomplish the said affixing means, where the needle lock and the quick pull handle is merged together.

3. A limiting means according to claim 1, comprising a pre-set adjustment knob, which is attached to the back end of the rear handle cap by thread, acting as a sleeve to allow the quick pull handle to be extended out of the back end of the pre-set adjustment knob and move back and forth in the axial direction.
